(19) United States
(12) Patent Application Publication
(10) Pub. No.: US 2021/0061038 A1
(43) Pub. Date: Mar. 4, 2021

(54) AIR SPRING BELLOWS FOR AIR SUSPENSION SYSTEMS

(71) Applicants: Reno N. Heon, Grover Beach, CA (US); Dustin B. Heon, Arroyo Grande, CA (US)

(72) Inventors: Reno N. Heon, Grover Beach, CA (US); Dustin B. Heon, Arroyo Grande, CA (US)

(21) Appl. No.: 17/004,896

(22) Filed: Aug. 27, 2020

Related U.S. Application Data
(60) Provisional application No. 62/894,176, filed on Aug. 30, 2019.

(51) Int. Cl. B60G 11/27

(52) U.S. Cl. CPC B60G 11/27; B60G 2206/73; B60G 2206/42; B60G 2202/152

(57) ABSTRACT

An air spring bellows for an air spring. The air spring may be used in suspension systems for automobiles, trucks, buses, trains, and industrial machines, among other applications. The air spring includes an air spring bellows. The bellows includes a flexible elastomeric substrate. The substrate is formed of polyurethane. Polyurethane may be the sole elastomer, or the majority of the elastomeric material, in the substrate. The substrate may be translucent. The bellows may include reinforcements, such as fiber cords. Plies of the fiber cords may be arranged within the elastomeric substrate.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. For example, this application claims the priority benefit of U.S. Provisional Patent Application No. 62/894,176, filed Aug. 30, 2019, the entire disclosure of which is hereby incorporated by reference herein in its entirety.

### TECHNOLOGY BACKGROUND

### Field

The technology relates to air suspension systems, and in particular, air springs.

### Description of the Related Technology

Air suspension systems are used in a variety of applications, including automobiles, trucks, buses, trains, and industrial machines. Such systems include air springs. Typical air springs have drawbacks with regard to strength, age, cost, and/or other factors. Typical air springs include bellows having an elastomeric substrate made of natural rubber, or a synthetic rubber blend. The elastomeric substrate is responsible for flexibly sealing the gas within the bellows.

Beginning over 100 years ago, air spring bellows or sleeves were constructed using natural rubber as the substrate material. Natural rubber has many known deficiencies for real-world applications (especially vehicle applications). These include deterioration of the initial physical properties of the natural rubber over its operating life resulting in premature air spring failure (lack of resistance to compression set, heat-aging, ozone, and ultraviolet light). Natural rubber also has a limited functional operating temperature range which causes failure of the air spring substrate when exposed to extremely cold or hot operating conditions. Once the elastomeric substrate of an air spring bellows or sleeve has failed, the air spring assembly will no longer seal the air or gas inside, which defeats the purpose of the air spring.

Due to the lack of performance of natural rubber, many synthetic rubber compounds have been developed over the years in an effort to improve the durability of air springs for real-world applications. These synthetic rubber blends usually include some amount of Neoprene (poly-chloroprene), NBR (nitrile rubber), EPDM (ethylene propylene diene monomer rubber), or SBR (styrene-butadiene), yet even the most optimal synthetic blends developed thus far still leave significant room for improvement.

### SUMMARY OF VARIOUS FEATURES

The embodiments disclosed herein each have several aspects no single one of which is solely responsible for the disclosure's desirable attributes. Without limiting the scope of this disclosure, its more prominent features will now be briefly discussed. After considering this discussion, and particularly after reading the section entitled “Detailed Description of Certain Embodiments,” one will understand how the features of the embodiments described herein provide advantages over existing systems, devices, methods and materials for air springs.

The technology described herein relates to an air suspension system and associated components, including air springs. The air springs include an air spring bellows. The bellows includes an elastomer component. The elastomer is formed of polyurethane. Polyurethane may be the sole elastomer in the bellows. The elastomer may be translucent. The bellows may include reinforcements, such as inelastic fibers, for example forming yarns or cords. The air spring with polyurethane elastomer provides superior durability, among other advantages.

In one aspect, an air spring for an automotive air suspension system is described. The air spring comprises a first end cap, a bellows, and a second end cap. The first end cap is configured to attach to a first vehicle component. The bellows has a rounded sidewall defining a longitudinal axis and extending from a first rounded opening to a second rounded opening opposite the first rounded opening to define an internal cavity. The first rounded opening is sealingly attached to the first end cap, with the internal cavity configured to receive pressurized air therein. The bellows sidewall includes a flexible elastomeric substrate, a first ply, and a second ply. The flexible elastomeric substrate comprises polyurethane, and the substrate comprises an inner layer, an outer layer located radially outward from the inner layer relative to the longitudinal axis, and a middle layer located in between the inner and outer layers. The first ply comprises a first series of parallel fiber cords, with the first ply located in between the inner and middle layers of the substrate such that the first series of parallel fiber cords extend at an angle with respect to the longitudinal axis. The second ply comprises a second series of parallel fiber cords, with the second ply located in between the middle and outer layers of the substrate such that the second series of parallel fiber cords extend at an angle with respect to the longitudinal axis and with respect to the first series of parallel fiber cords, and such that the first and second series of parallel fiber cords define a series of equally-sized cells. The second end cap is sealingly attached to the second rounded opening of the bellow, with the second end cap configured to attach to a second vehicle component.

In one aspect an air spring is described. The air spring is for an automotive air suspension system, but may be used with other suitable applications. The air spring comprises a bellows having a rounded sidewall defining an axis and extending from a first rounded opening to a second rounded opening. The bellows is configured to receive pressurized air therein, and includes a flexible elastomeric substrate that comprises polyurethane.

Various embodiments of the various aspects may be implemented. The air spring may further comprise a first end cap attached to the first rounded opening, and a second end cap attached to the second rounded opening. The elastomeric substrate may be translucent. The elastomeric substrate may be transparent.

The air spring may further comprise a plurality of fiber cords embedded within the elastomeric substrate. A first end of the fiber cords may begin at the first rounded opening and a second end of the fiber cords may end at the second rounded opening. The fiber cords may be equally spaced from one another. The fiber cords may be oriented at an angle with respect to the axis. The fiber cords may extend parallel to the axis. The fiber cords may comprise a first plurality of fiber cords located on a first ply, with the first ply being located adjacent to a layer of the substrate of the sidewall. The fiber cords may further comprise a second plurality of fiber cords located on a second ply, with the second ply being located on a second side of the layer of the substrate that is opposite from the first side. The first and second plies may be oriented such that the first fiber cords are angled with respect to the second fiber cords. The fiber cords may be angled with respect to each other so as to define a plurality of cells. The cells may be sized according to an operating parameter of the air spring. The operating parameter may comprise one or more of a load on the air spring, an operating temperature range of the air spring, and size of the air spring. The polyurethane may be different from a thermoplastic polyurethane.

In another aspect, an air suspension system comprising one or more air springs is described. The air suspension system may comprise any of the various aspects and embodiments of the air springs described herein.

In another aspect, a composition for an air spring bellows is described. The composition comprises polyurethane. The air spring bellows may be used in an air spring, for example along with two end caps. The air spring may be configured for use in any of the air suspension systems described herein. The polyurethane may be different from a thermoplastic polyurethane.

In another aspect, a bellows for an air spring is described. The bellows is formed of a material comprising an elastomer that comprises polyurethane. The bellows may be used in an air spring, for example along with two end caps. The air spring with the bellows may be configured for use in any of the air suspension systems described herein. The elastomer may comprise only polyurethane. The elastomer may comprise more than 50% polyurethane by weight or volume of the elastomer. The polyurethane may be different from a thermoplastic polyurethane.

The foregoing summary is illustrative only and is not intended to be in any way limiting. In addition to the illustrative embodiments and features described herein, further aspects, embodiments, objects and features of the disclosure will become fully apparent from the drawings and the detailed description and the claims.

### BRIEF DESCRIPTION OF THE DRAWINGS

The foregoing and other features of the present disclosure will become more fully apparent from the following description and appended claims, taken in conjunction with the accompanying drawings. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawing, can be arranged, substituted, combined, and designed in a wide variety of different configurations, all of which are explicitly contemplated and make part of this disclosure.

FIG. 1 is a schematic representation of an automobile that includes an air suspension system having embodiments of an air spring with a bellows.

FIG. 2A is a perspective view of the air spring with a bellows from FIG. 1.

FIG. 2B is a partial cross-section view of the air spring of FIG. 2A taken along the line 2B-2B as indicated in FIG. 2A.

FIG. 2C is a detailed view of a cross-section of the bellows sidewall of the air spring of FIG. 2B taken within detail 2C as indicated in FIG. 2B.

FIG. 2D is a detailed view of the bellows of the air spring of FIG. 2B taken within detail 2D as indicated in FIG. 2B.

FIG. 3 is a flowchart showing an embodiment of a method for making the air spring of FIG. 1.

FIGS. 4A-4G illustrate additional embodiments of air springs, having various embodiments of a bellows, that may be used in the automobile of FIG. 1.

### DETAILED DESCRIPTION OF CERTAIN ILLUSTRATIVE EMBODIMENTS

The following detailed description is directed to certain specific embodiments of the technology. In this description, reference is made to the drawings wherein like parts or steps may be designated with like numerals throughout for clarity. Reference in this specification to “one embodiment,” “an embodiment,” or “in some embodiments” means that a particular feature, structure, or characteristic described in connection with the embodiment is included in at least one embodiment of the invention. The appearances of the phrases “one embodiment,” “an embodiment,” or “in some embodiments” in various places in the specification are not necessarily all referring to the same embodiment, nor are separate or alternative embodiments necessarily mutually exclusive of other embodiments. Moreover, various features are described which may be exhibited by some embodiments and not by others. Similarly, various requirements are described which may be requirements for some embodiments but may not be requirements for other embodiments.

Various embodiments of an air spring are described herein which are constructed of a flexible bellows. “Bellows” as used herein refers to its usual and customary meaning and includes without limitation a component or components of an air spring that forms a flexible sidewall or sidewalls of the air spring, and may be in a straight or substantially straight configuration relative to a longitudinal axis thereof, such as a “sleeve” arrangement, or it may be in a rounded or substantially rounded configuration, such as a “bellows” air spring with a more bulging-type sidewall. Various embodiments include a cylindrical, sleeve-type bellows. Other embodiments include a bulging-type bellows. The bellows is joined, for example circumferentially joined, at top and bottom ends to upper and lower end-caps, respectively, which may be non-flexible. The end-caps may include one or more pneumatic couplings for adding or releasing an amount of gas within the air spring. The upper and lower end-caps include attachments for mechanically affixing the air spring to a components, such as a vehicle or machine in which the air spring is to be used.

Various embodiments described herein relate to an air spring bellows for an air spring. The air spring may be used in suspension systems for automobiles, trucks, buses, trains, and industrial machines, among other applications. The air spring includes an air spring bellows. The bellows includes a flexible elastomeric substrate. The substrate is formed of polyurethane. Polyurethane may be the sole elastomer, or the majority of the elastomeric material, in the substrate. The substrate may be translucent. The bellows may include reinforcements, such as fiber cords. Rows of the cords may be embedded within the elastomeric substrate. The bellows having the elastomeric substrate described herein provides many advantages over existing substrate materials for air springs, including, for example, drastic improvement to the overall life expectancy, improved key air spring performance attributes, and improved manufacturability for low production fallout.

The bellows is constructed of one or more internal reinforcement layers bonded to the elastomeric substrate. As used herein, the terms “internal reinforcement,” “internally reinforced” and the like, include their usual and ordinary meaning and include the use of substantially inelastic cords or fibers (e.g., filaments, strands, yarns and threads) and/or plies of fabric, or other sections of material made therefrom that are embedded within a wall of an elongated tubular body formed from an elastomeric material to help restrict or otherwise limit the expansion thereof. Exemplary “substantially inelastic filaments” include polyester, nylon, rayon, or aramid fibers. The reinforcement cords provide various functions, including controlling the diameter of the air spring when pressure is applied by radially restraining the shape of the bellows, for example restraining to a cylinder rather than a sphere.

These are merely some example embodiments of the air spring systems, devices, methods and materials described herein. Further details of these and other embodiments are described below.

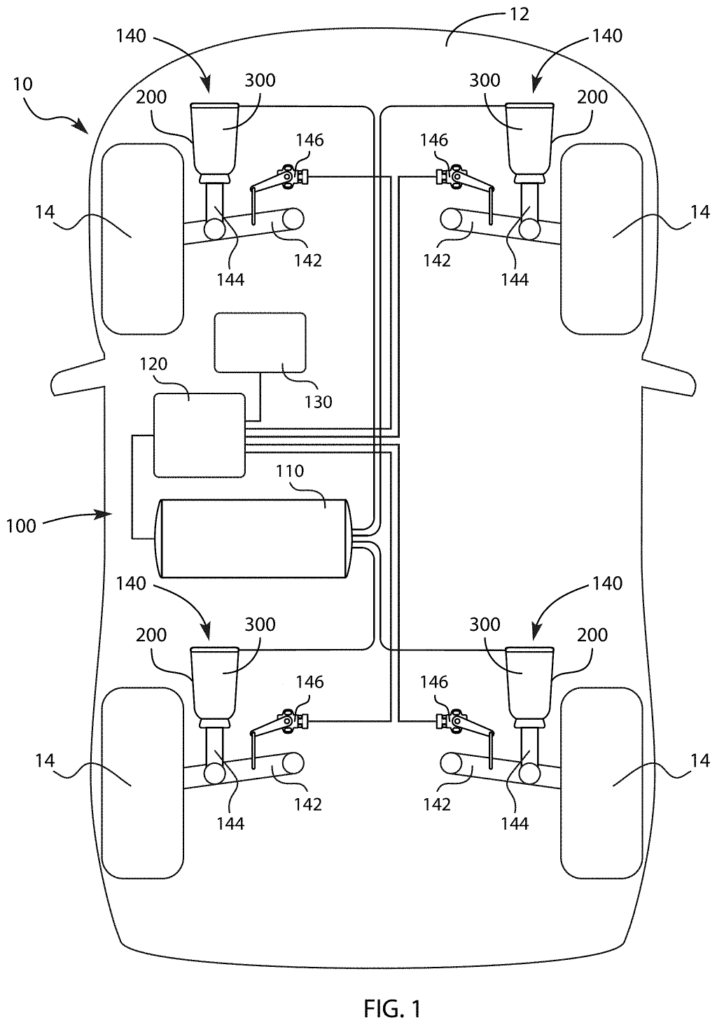

FIG. 1 is a schematic representation of an embodiment of an automobile 10 that includes an embodiment of an air suspension system 100 having several air suspension subsystems 140 each with an air spring 200 having a bellows 300. The air suspension system 100 includes a compressor valve tank 110 for storing compressed air to be delivered to the air springs 200 via one or more supply lines. The tank 110, such as the ENDOTM line of tanks by Accuair Control Systems in San Luis Obispo, Calif., is electronically connected (wired or wirelessly) to an electronic control module 120 that controls the delivery of air from the tank 110, such as a compressor valve tank, to the air springs 200. A user interface 130, such as a control pad within the passenger cabin or app on a mobile device, is used to interface (wired or wirelessly) with the electronic control module 120 to control the air suspension system 100. The electronic control module 120, such as the E-LEVELTM and SWITCH SPEEDTM systems from Accuair Control Systems, is electronically connected (wired or wirelessly) to each of the subsystems 140. The electronic control module 120 receives data sensed by the subsystems 140, such as a height sensor 146 as further described, to analyze and provide output (e.g., auto or manual control, feedback to the user via the user interface 130, etc.) regarding the air provided to or in each air spring 200 in order to, for example, control the height of the automobile.

The automobile 10 may be a car, truck, or other type of vehicle. The air suspension system 100 may be used with other applications besides vehicles, such as industrial machines, aircraft, and other suitable uses. The automobile 10 includes a body 12 with four wheels 14. The air suspension system 100 includes four of the air suspension subsystems 140, each subsystem 140 located at one of the four wheels 14. There may be more or fewer than four subsystems 140.

Each subsystem 140 includes the air spring 200. The air spring 200 attaches on a first end to a frame, body, or other structure of the automobile 10 and on a second opposite end to a damper 144. The damper 144 may be mechanically or electronically controlled to manage the motion of the subsystem 140. The air spring 200 may be aligned axially with the gravity vector on horizontal ground. In some embodiments, the air spring 200 may be mounted at some angle with respect to the gravity vector depending on vehicle packaging requirements. The schematic depiction and orientation of the air springs 200 in FIG. 1 is for illustration purposes only.

The damper 144 is attached to a respective control arm 142. The arm 142 attaches to a respective one of the wheels 14. As the automobile 10 travels over uneven terrain or roads, the wheels 14 will be moved up and down accordingly, which will cause movement of the respective arm 142. As the arm 142 moves up and down, the force is absorbed by the damper 144 and air spring 200. The air spring 200 reduces and/or prevents accelerations, vibrations, or noise, etc. from being transmitted to the frame of the automobile 10, allowing for a smoother ride and experience.

The height sensor 146 detects the relative movement of the control arm 142. The amount and/or rate of movement of the control arm 142 may be detected. The movement data is sent to the electronic control module 120, which may automatically adjust (for example increase or decrease) the amount of air within one or more of the air springs 200, for example by delivering more compressed air from the tank 110. The operating principle of the height sensor 146 may be resistive, capacitive, magnetic, optical, acoustic, or relative.

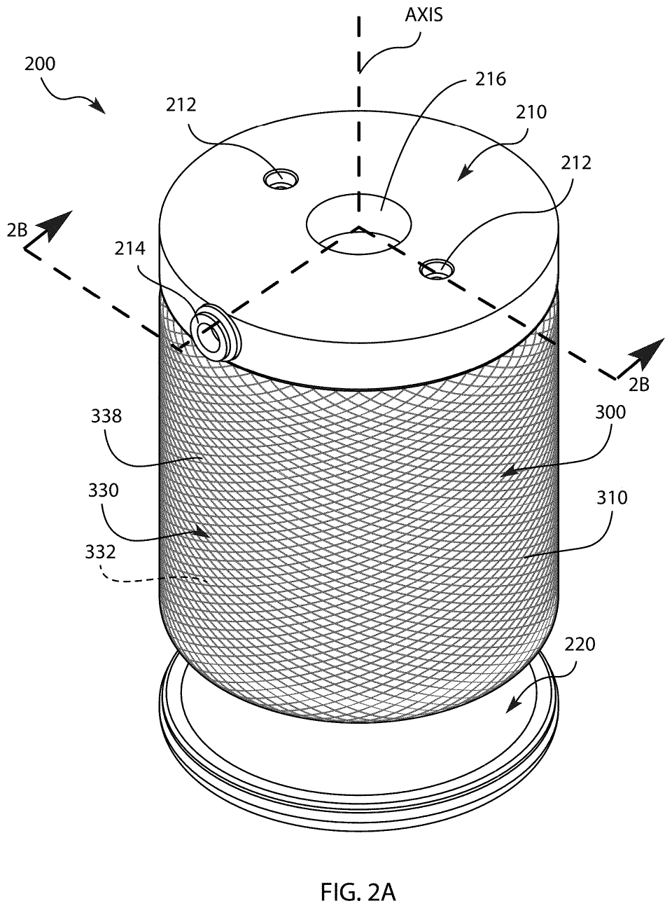

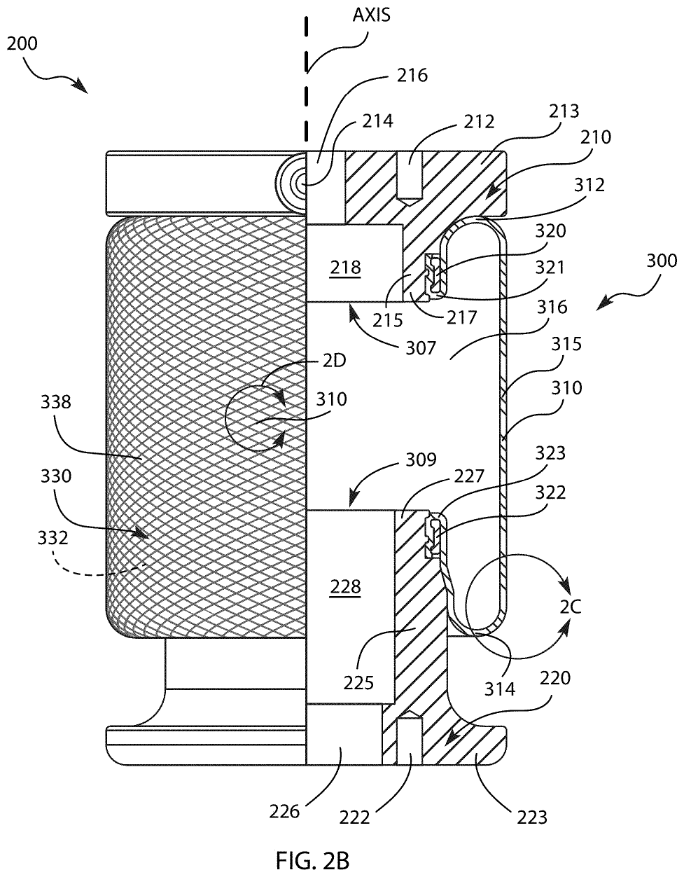

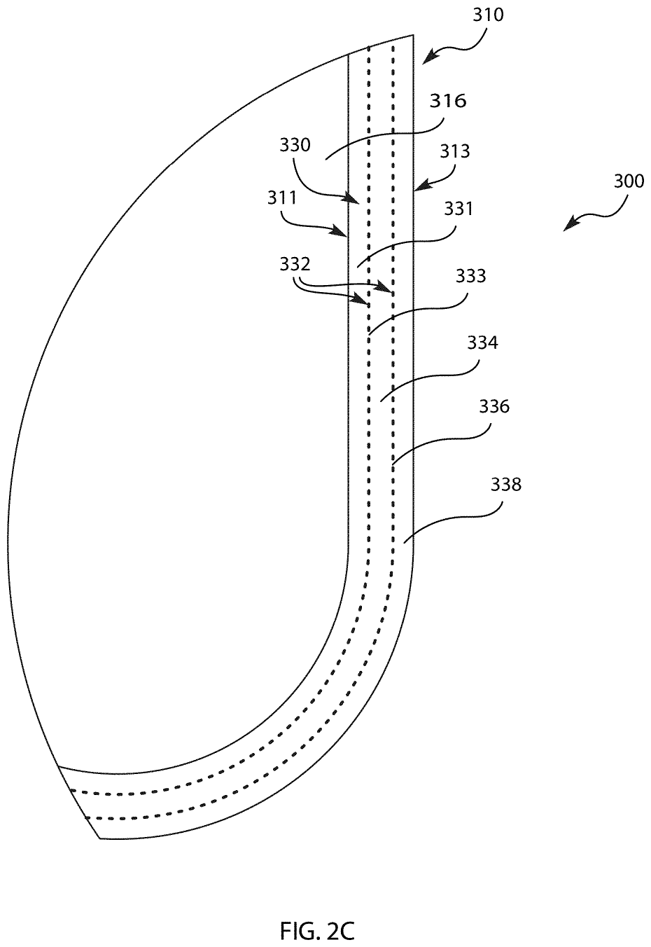

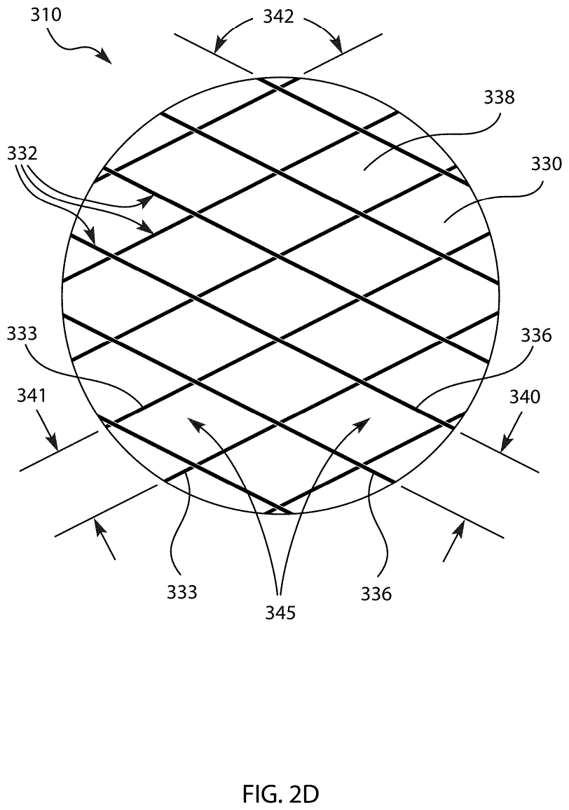

FIG. 2A is a perspective view of the air spring 200. A longitudinal axis is shown for geometric reference. The air spring 200 includes the bellows 300 having a flexible sidewall 310. The air spring 200 further includes a first end cap 210 attached to a first end of the bellows 300 and a second end cap 220 attached to an opposite second end of the bellows 300. The bellows 300 in FIG. 2A is shown as a “sleeve” style bellows. The bellows 300 may have a broad range of sizes. The sleeve-type bellows 300 may inflate and form a lobe at an end thereof that rolls onto another portion of the air spring 200, such as a piston, as further described. The shape of the piston and the volume of the air spring control the spring rate which makes it highly adjustable and a suitable option for vehicle air suspension systems.

The first end cap 210 is configured to be attached to a structure, such as the frame of the automobile 10 (see FIG. 1). The second end cap 220 is configured to attach to an oscillating component, such as the control arm 142 via the damper 144 (see FIG. 1). The first end cap 210 is shown with a different structure than the second end cap 220, but in some embodiments they may be the same or similar. As shown, the first end cap 210 includes attachments 212, shown as holes, which are configured to attach the first end cap 210 to a structure. For example, fasteners may be used to secure the first end cap 210 to the automobile frame. The first end cap 210 includes an opening 216 configured to receive therein pressurized air from the compressor valve tank 110 via air supply lines (see FIG. 1). The first end cap 210 includes a coupling 214, such as a pneumatic coupling or valve, which may allow air to be added or removed from the air spring 200.

FIG. 2B is a partial cross-section view of the air spring 200, taken along the line 2B-2B as indicated in FIG. 2A. As shown, the first and second end caps 210, 220 are circular about the axis. The first and second end caps 210, 220 may be other shapes, such as rounded, annular, polygonal, segmented, other suitable shapes, or combinations thereof. The first and second end caps 210, 220 may generally have a “hat section” shape. The first end cap 210 has a sidewall 215 that extends axially to a flange 213 that extends radially outward at an axial end of the first end cap 210. The second end cap 220 has a sidewall 225 that extends axially to a flange 223 that extends radially outward at an axial end of the second end cap 220. The flanges 213, 223 define a space there between in which the bellows 300 is partially located, as further described. The sidewall 215 defines a cavity 218 within the first end cap 210. The sidewall 225 defines a cavity 228 within the second end cap 220. The sidewall 215 of the first end cap 210 is shorter than the sidewall 225 of the second end cap 220. The sidewalls 215, 225 may or may not have the same or similar inner and outer widths. The sidewalls 215, 225 extend to respective inner ends 217, 227 that attach to respective ends 321, 323 of the bellows 300. The inner ends 217, 227 include annular grooves configured to receive therein a respective portion of the bellows 300 that is compressed into the grooves by a respective clamp 320, 322, as further described.

The bellows 300 includes the sidewall 310. The sidewall 310 extends axially from a first opening 307 to an opposite second opening 309, which openings may be circular, or other rounded or suitable shapes. The first end 321 of the sidewall 310, such as a first lobe, is attached to the first end cap 210 at the inner end 217 and wraps around the clamp 320. The clamp 320 maintains a radially inward force on the first end 321 of the bellows sidewall 310 to provide a sealing engagement of the bellows 300 with the first end cap 210 at this first annular interface. A similar second annular interface is located at the second end 323, such as at a second lobe, of the bellows sidewall 310 and the inner end 227 of the second end cap 220 using the clamp 322.

The sidewall 310 may have a variety of different contours and configurations, depending on the application, desired spring rate, packaging space, etc. As shown, the cross-section of the sidewall 310 extends from the first end 321 at the inner end 217 of the first end cap 210 and wraps around and up to the flange 213 of the first end cap 210, then extends under the flange 213 along a first curved portion 312 of the sidewall 310, then extends axially downward toward the second end cap 220, then extends along a second curved portion 314 near the second flange 223, and to the second end 323 which wraps around the clamp 322 at the inner end 227 of the second end cap 220. The upper portion or portions of the bellows 300 may form the first lobe, such as the first end 321 and/or the first curved portion 312. The lower portion or portions of the bellows 300 may form the second lobe, such as the second end 323 and/or the second curved portion 314. This is merely one example configuration and many others may be implemented. Further, the use of “up” and “down” and the like is for clarity only and is not limiting as to the possible orientations and configurations of the bellows 300.

The bellows 300 defines a cavity 316 located between the annular sidewall 310. The cavity 316 is configured to receive pressurized air or other compressible gasses therein. The bellows cavity 316 is in fluid communication with the cavities 218, 228 of the first and second end caps 210, 220. As the automobile or other application applies more or less compressive load to the air spring 200, the first and second ends 321 and 323 and/or curved portions 312 and 314 of the bellows 300 may roll on the respective adjacent sidewalls 215 and 225 to allow the bellows 300 to lengthen or shorten accordingly. The bellows 300 may flex outward or inward as a result of higher or lower pressure in the cavity 316 due to a flexible elastomeric substrate therein but may be limited in the amount of flex due to inelastic cords therein, as further described. The bellows 300 may include a straight or substantially straight section 315 extending between the first curved portion 312 and the second curved portion 314. In some embodiments, the section 315 may be rounded or partially rounded.

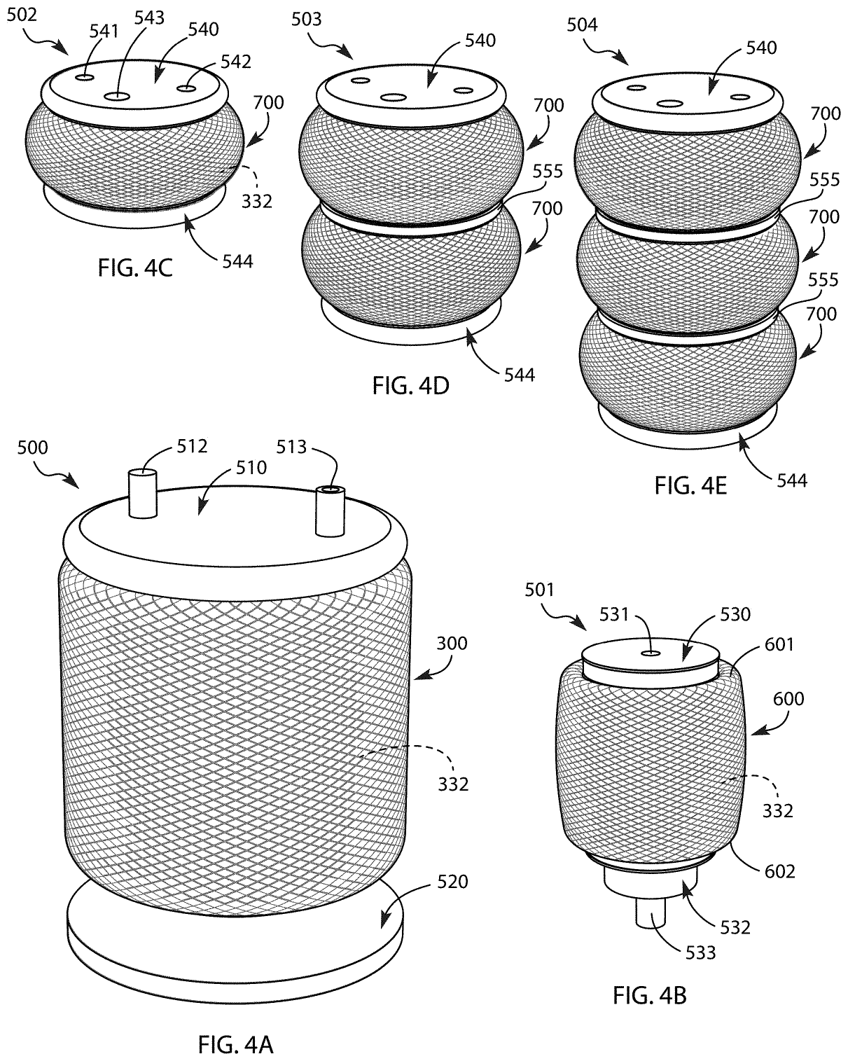

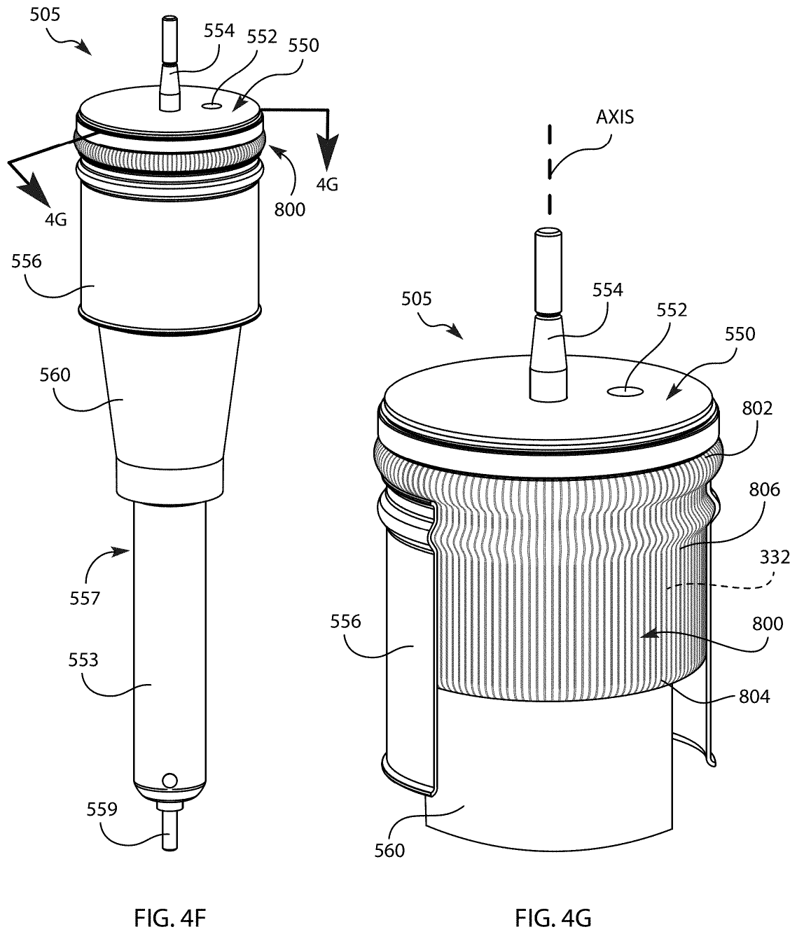

There is a single bellows 300 in the air spring 200. In some embodiments, there may be multiple bellows 300 in the air spring 200. For example, there may be two, three, four or more of the bellows 300. The bellows 300 may be stacked axially on each other, such that the air spring 200 may include multiple straight sections 315, etc. The multiple bellows 300 may form a continuous air cavity therein. The features described herein at the first and second ends 321, 323 of the bellows 300 may be incorporated in whole or in part between two stacked bellows 300. Other embodiments of the bellows 300, such as the bulging type bellows as further described herein, for example with respect to FIG. 4, may also include multiple bulging sections and thus may incorporate similar features between bulging sections as a stack of multiple bellows 300, and vice versa.

FIG. 2C is a detailed view of a cross-section of the sidewall 310 of the bellows 300 taken within detail 2C as indicated in FIG. 2B. As shown in FIG. 2C, the sidewall 310 includes a flexible elastomeric substrate 330. The substrate 330 includes polyurethane. The substrate 330 may include only or mostly polyurethane. The substrate 330 and/or the bellows 300 may be composed of 50% or more, 60% or more, 70% or more, 80% or more, 90% or more, or 95% or more polyurethane, by weight or by volume. The polyurethane may include two monomers, isocyanates and polyols linked via urethane linkages. Note that although urethane linkages are present in polyurethane, it is not made of urethane monomers. In contrast, urethane is a chemical compound having both an ester group and an amide group along with a carbonic acid. The polyurethane of substrate 330 may be polyester type polyurethane, or polyether type polyurethane, and may be peroxide catalyzed, or sulfur catalyzed. The polyurethane of substrate 330 may also contain numerous fillers and additives such as stearic acid, fumed silica, plasticizers, antidegradants, ultraviolet stabilizers, colorants, curing agents, and coagents for example. The vulcanized or cured polyurethane of substrate 330 may have a finished durometer between 40A to 65D.

The polyurethane used in the bellows 300 may be different from “thermoplastic” polyurethane (TPU), which has no urethane cross linking and typically melts into a liquid when heated and typically is not flexible after cooling. Thermoplastic (or melted thermoplastic) is known in the art to be deposited and used between component parts to form a fixed and/or substantially fluid-tight connection therebetween. An example of a thermoplastic polyurethane can be found in U.S. Pat. No. 9,127,737, titled “Unreinforced elastomeric spring wall, gas spring and method,” and issued Sep. 8, 2015, the entire disclosure of which is incorporated by reference herein. In contrast, the polyurethane used in the substrate 330 of the bellows 300 is a thermoset polyurethane (PU), which has urethane cross linking and is cured through vulcanization. Further, the polyurethane used in substrate 330 of the bellows 300 may not melt into a liquid when heated.

There are three layers 331, 334, 338 of the substrate 330, each with a series of fibers in between, as further described. An inner layer 331 of the substrate 330 is located on an inner side of the sidewall 310. An outer layer 338 of the substrate 330 is located on an outer side of the sidewall 310. A middle layer 334 of the substrate 330 is located in between the inner and outer layers 331, 338. The inner layer 331 includes an inner surface 311 that faces the interior cavity 316 of the bellows 300. The outer layer 338 includes an outer surface 313 that faces outwardly from the bellows 300. Layers 331, 334, and 338 may each have a radial wall thickness ranging from 0.015″-0.125″ (inches). The thickness of each layer 331, 334, 338 may be sized depending on the performance requirements of the bellows 300. Layers 331, 334, and 338 may all be constructed of polyurethane. In some embodiments, one or more of the layers 331, 334, and 338 may not be constructed of polyurethane. The polyurethane of the layers 331, 334, and 338 may be of the same durometer for all layers, or may be different durometers for one or more of the layers 331, 334, 338. There may be fewer or more than three layers of the substrate 300. There may be one, two, four, five, six, seven, eight, nine, ten or more layers of the substrate 300.

The substrate 330 may be translucent. The substrate 330 may allow some light to pass through the substrate. The substrate 330 may be transparent, whereby most light can pass through it. The substrate 300 may have a transparency (or clarity, transmittance, and the like) as measured using standard transparency tests, such as ASTM D1746-15, of more than 20%, more than 30%, more than 40%, more than 50%, more than 60%, more than 70%, more than 80%, or more than 90%. The advantages of the translucent substrate 330 as they relate to construction of the bellows 300 will be further described.

The sidewall 310 includes a series of cords 332. As shown, there is a first ply 333 or sheet of the cords 332, and a second ply 336 or sheet of cords 332. Each ply 333, 336 may include a series of the cords 332. Some, all or substantially all of the cords 332 within each ply 333, 336 may be arranged parallel to each other and spaced equally apart from one another. The cords 332 are inelastic or substantially inelastic and elongated. The cords 332 may be formed from polyester, nylon, rayon, or aramid fibers. One or more fibers may be twisted together to form the elongated cord 332. Each of the cords 332 may have a linear mass density from 400 to 2,000 decitex (“dtex”). As used herein, “dtex” has its usual and ordinary meaning, including a unit of measure for the linear mass density of a single cord 332 formed from a plurality of the fibers, and is defined as the mass in grams per 10,000 meters. Each of the cords 332 may have a finished diameter from 0.005″ to 0.045″ (inches). The cords 332 may also be dipped in an adhesion promoter such as RFL (resorcinol formaldehyde latex), or a polyurethane adhesion promoter in order to facilitate proper bonding of the cords 332 to the substrate 300. The cords 332 provide reinforcement and radial structural integrity to the bellows 300. The cords 332 extend at an angle with respect to the axis (see FIGS. 2A, 2B and 2D). In some embodiments, some or all of the cords 332 may be aligned with the axis. For example, some embodiments of an air spring using the polyurethane bellows described herein may have the cords 332 aligned with a longitudinal axis of the air spring, as further described herein for example with respect to FIGS. 4F-4G.

As further shown in FIG. 2C, the cords 332 are arranged in a respective ply 333, 336 located between respective layers 331, 334, 338 of the substrate 330. The first ply 333 is located between the inner and middle layers 331, 334 of the substrate 330. The second ply 336 is located between the middle and outer layers 334, 338 of the substrate 330. There may be fewer or more than two plies 333, 336 of the cords 332. In some embodiments, there may be one, three, four, five, six, seven, eight, nine, or more plies of the cords 332.

FIG. 2D is a detailed view of the outer sidewall 310 of the bellows 300 taken within detail 2D as indicated in FIG. 2B. As shown in FIG. 2D, the cords 332 (for clarity, only some of the cords 332 are labelled in the figure) within the ply 333 are aligned, for example parallel, with each other. All or some of the cords 332 within the ply 333 may be parallel to each other. The cords 332 within the ply 333 are spaced from each other by a spacing 341. Likewise, the cords 332 within the ply 336 are aligned, for example parallel, with each other. All or some of the cords 332 within the ply 336 may be parallel to each other. The cords 332 within the ply 336 are spaced from each other by a spacing 340. The spacings 341 and 340 are the same or substantially the same. In some embodiments, the spacings 341 and 340 may not be the same. The spacings 341, 340 are uniform within each of their respective plies 333, 336. In some embodiments, some of the spacings 341, 340 may not be uniform with their respective plies 333, 336. A first end of each of the cords 332 may extend from the first end 321 of the bellows 300 sidewall 310 (see FIG. 2B) to a second opposite end of the respective cord 332 located at the opposite second end 323 of the sidewall 310. In some embodiments, some or all of the cords 332 may not extend to one or the other of the ends 321, 323.

The cords 332 within the ply 333 are angled with respect to the cords 332 within the ply 336. As shown, the cords 332 of the ply 333 are angled with respect to the cords 332 within the ply 336 at an obtuse angle 342 relative to each other. This angle 342 between the cords 332 may be visible when viewing the air spring from the side. The angle 342 may change during inflation and expansion, and/or during deflation and contraction, of the sidewall 310 of the bellows 300. In some embodiments, the angle 342 may reach a maximum of 132 degrees or of about 132 degrees after inflation, which may be after full inflation. In some embodiments, the angle 342 may start at some angle less than 132 degrees or less than about 132 degrees prior to inflation, or after deflation. In some embodiments, the angle 342 may be more than 90 degrees, about 95 degrees, about 100 degrees, about 105 degrees, about 110 degrees, about 120 degrees or more. In some embodiments, the angle 342 may be 95 degrees, 100 degrees, 105 degrees, 110 degrees, 120 degrees or more.

In some embodiments, and as shown in FIG. 2D, one of the plies is at an opposite angle to another of the plies. For instance, if a first ply is arranged at an angle of 66 degrees with respect to the axis, a second ply may be arranged at an angle of −66 degrees with respect to the axis, etc. Such an opposing arrangement may contribute to a rotational balance of forces. This may remove or reduce rotational forces applied to the air spring during inflation, and thus prevent the air spring from rotating as it inflates. Various configurations may be implemented. For example, in embodiments with two or more plies of the cords 332, two or more of the plies may have the cords 332 angled with each other. For example, with four total plies, two plies may be aligned with each other and angled with respect to the other two plies which may be aligned with each other. As further example, with three total plies, an inner and outer ply may have cords 332 angled with each other, while a middle ply between the inner and outer plies may have cords 332 arranged axially such as parallel to a longitudinal axis of the air spring.

The cords 332 define a series of cells 345. The cells 345 are shown as viewed from the side of the bellows 300, for example radially to the longitudinal axis. The cells 345 are defined by adjacent cords 332 within each of the plies 333, 336 that overlap a common location on the sidewall 310. Thus two or more plies may include cords 332 that define or form the cells 345. The cell 345 has four sides because there are two plies 333, 336 in the illustrated embodiment. The cells 345 may have a diamond shape as shown. The cells 345 may have other shapes, for example where more than two plies are used. As shown, the cells 345 define quadrilateral shapes having four sides and four inner angles. Two of the opposing angles are equal to the angle 342 as described, and each of the other two opposing angles are equal to half of the difference between 360 degrees and two times the angle 342. The fiber cords may be angled with respect to each other so as to define the plurality of cells 345.

The cells 345 may be sized, for example equally sized, according to an operating parameter of the air spring 200. The operating parameter may comprise one or more of a load on the air spring 200, an operating temperature range of the air spring 200, and size of the air spring 200. The sizing of the cells 345 cause the air spring 200 to operate with extended life, improved durability, and improved performance characteristics. The cords 332 within a single ply may be parallel and equally spaced such that all or most of the cells 345 are equally sized and spaced. The cell size may facilitate achieving durability with the spring. For example, a proper size of the cells 345 will prevent the elastomer substrate material from extruding between the reinforcement fiber cords, which could lead the elastomer substrate to wear off, and possibly cause the air spring to leak.

One advantage of the translucent substrate 330 is to allow for the visual validation or control of the placement and spacing of the cords 332 as described above during the construction of the bellows 300. In contrast, when conventional non-translucent materials are used for substrate 330 it is difficult or impossible to validate or control the placement and spacing of the cords 332 during the construction of the bellows 300.

The polyurethane of the substrate 330 may be fully cured during the vulcanization process.

This may yield a finished bellows 300 that has consistent material properties for its entire operating life. For example, the durometer, modulus of elasticity, and yield strength of the bellows 300 immediately after production may be the equivalent, or nearly equivalent, to the durometer, modulus of elasticity, and yield strength off the bellows 300 after extended use and exposure, for example after months or years, to operating conditions such as high temperatures. Vulcanization as used herein refers to its usual and ordinary meaning, including but not limited to the curing of an elastomer, for example a chemical process for treatment and/or cross-linking of the molecular chains of the substrate 330 via various means. The cross-linked polyurethane may have improved dimensional stability and elasticity, as well as other changes in the mechanical and electrical properties of the polyurethane and/or substrate 330. The amount of vulcanization performed on the substrate 330 may be developed with a rheometer. A rheometer is a laboratory device designed for measuring visco-elastic properties of rubber compounds during the vulcanization process. The vulcanization of the polyurethane may be irreversible.

The polyurethane of the substrate 330 may be cured to T100. In contrast, conventional materials for bellows (i.e., materials other than polyurethane), such as natural rubber, or synthetic rubber blends such as Neoprene (poly-chloroprene), NBR (nitrile rubber), EPDM (ethylene propylene diene monomer rubber), or SBR (styrene-butadiene), may be partially cured to T90 in order to yield acceptable material properties immediately after production. T90 refers to the vulcanization time required for the elastomer to reach 90% of the highest measurable rheometer torque possible for the material. Exceeding T90 with certain types of compounds (NR, CR), can cause a danger to over-cure the compound. This is known as a reversion in cure, typically flowed by drop in hardness and other physical properties. It can also happen that the rheometer torque continues to rise which is typical for EPDM based compounds. However, a partially cured substrate 330 such as T90 may have the associated disadvantage of degrading material properties over its operating life. For example, for a cure of T90 the durometer, modulus of elasticity, and yield strength of the bellows 300 immediately after production may be significantly different to the durometer, modulus of elasticity, and yield strength off the bellows 300 after many years of operation and exposure to extreme conditions such as high temperatures. These degraded material properties may cause such bellows to prematurely fail. Thus the bellows 300 described herein having a fully cured or nearly fully cured polyurethane substrate provides an improvement to existing solutions, as described herein.

The polyurethane of substrate 330 may have additional performance advantages over conventional substrate materials due to the substrate's 330 improved material properties, such as lower compression set, extended heat aging resistance, improved ozone resistance, higher gas impermeability, improved dynamic service/abrasion resistance, improved tear strength, and/or higher resilience resulting in lower hysteresis.

Further, the resources required to manufacture the polyurethane of substrate 330 may be more sustainable over conventional substrate materials. The polyurethane of substrate 330 may be manufactured entirely with materials that are synthetically manufactured. Conventional substrate materials may require the use of one or more organic materials such as latex which is harvested from trees and has a limited renewability.

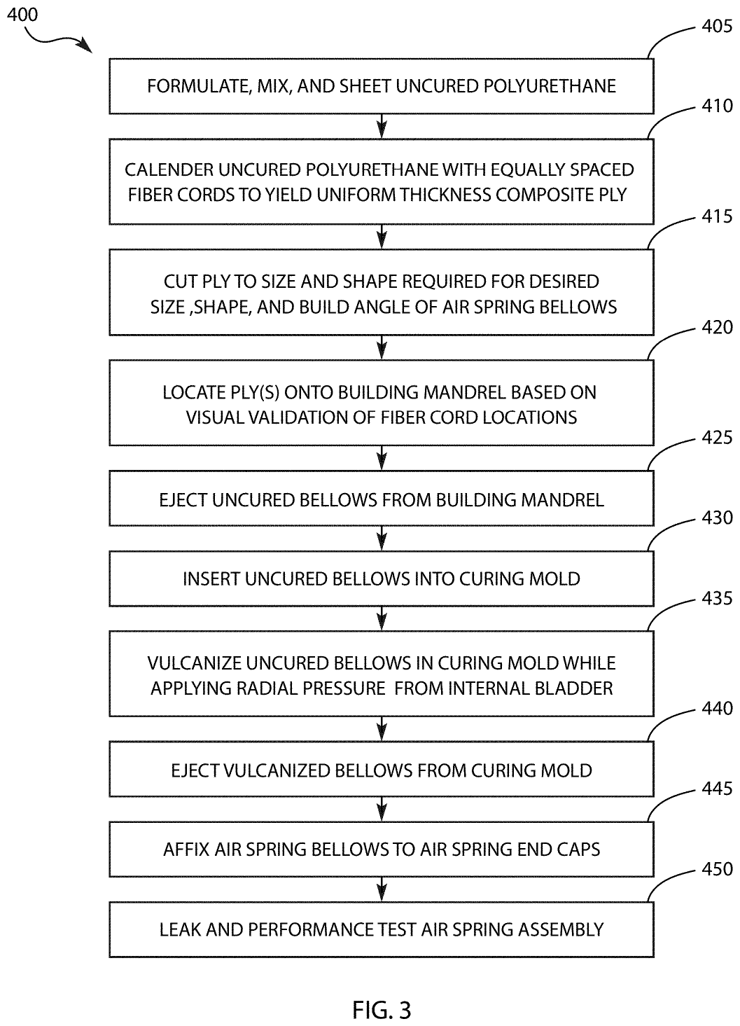

FIG. 3 is a flowchart showing an embodiment of a method 400 for making the air spring 200. The method 400 may be used to make the air spring 200 having the bellows 300 and the end caps 210, 220, as well as for testing the air spring 200. In some embodiments, only some of the steps of the method 400 may be used, for example to only build the air spring 200 but without testing it.

The method 400 begins with step 405 where uncured millable polyurethane is formulated, mixed and sheeted with a. The finished uncured polyurethane sheet may range in thickness between 0.015″-0.125″.

The method 400 next moves to step 410 where the uncured polyurethane is calendered or combined with fiber cords. The polyurethane for the substrate 330 may be calendered with the cords 332. The polyurethane may be calendered with equally spaced cords 332 to yield a uniform thickness composite ply. Several layers of multiple widths and thicknesses may be formed that constitute a single ply. Several plies may be formed that may be combined together. Step 410 may include forming, e.g., twisting, multiple fiber filaments to form the cords 332.

The method 400, for instance the step 410, may be modified such that the uncured millable polyurethane may be mixed and then extruded around the equally spaced cords 332 to yield a uniform thickness composite ply. Several layers of multiple widths and thicknesses may be formed that constitute a single ply. Several plies may be formed that may be combined together.

The method 400 next moves to step 415 where the ply is cut to a desired size and shape. The ply may be cut based on requirements for the desired size, shape and build angle of the bellows 300. For a build angle of zero, i.e., vertically placed fibers during the build process, the ply may be cut in a rectangular shape having a width based on the circumference of the bellows 300 plus some mating length and a height based on the axial height of the bellows 300. For a build angle other than zero, the ply may be cut in a parallelogram shape. The sides that are non-parallel to the fiber cords may have a length equal to the circumference of the bellows 300 plus some mating length. The sides parallel to the fiber cords may be cut at the length required to achieve the desired axial height of the bellows 300.

The method 400 next moves to step 420 where the one or more plies are placed onto a building mandrel. The plies may be located on the mandrel based on visual validation of the fiber cord locations (which is not possible without a translucent or transparent substrate 330), such as accurately achieving the orientations described herein with respect to FIG. 2D. Thus the translucence of the polyurethane bellows substrate as described herein may provide advantages for the manufacturing process that result in superior durability and the other advantages as described herein.

The method 400 then moves to step 425 where the uncured bellows is ejected, i.e., removed, from the building mandrel. The method 400 then moves to step 430 where the uncured bellows is inserted into a curing mold with the desired final shape of the bellows 330 described herein, for example FIGS. 2A-2D.

The method 400 then moves to step 435 where the uncured bellows is vulcanized in the curing mold with the addition of heat. The bellows is vulcanized while applying radially outward pressure from an internal bladder in order to avoid the formation of air pockets or voids in the finished bellows 300. The polyurethane may be fully cured to T100 during this vulcanization process which yields a finished bellows 300 that has consistent material properties for its entire operating life.

The method 400 then moves to step 440 where the vulcanized bellows is ejected, i.e., removed, from the curing mold.

The method 400 then moves to step 445 where the bellows is affixed to the end caps to form an air spring. The bellows 300 may be attached to the first and second end caps 210, 220 as described herein, for example using the clamps 320, 322 as shown and described with respect to FIG. 2B.

The method 400 then moves to step 450 where the air springs are tested. The air springs 200 may be tested for leaks, performance, etc.

FIGS. 4A-4G illustrate additional embodiments of air springs with a bellows that incorporate the polyurethane substrate with fiber cords. The air springs may be used in the automobile 10 or other applications as described herein. The air springs of FIGS. 4A-4G may incorporate any of the various arrangements of the cords 332 as described herein, for example with respect to FIGS. 2A-2D.

FIG. 4A shows an embodiment of an air spring 500 that includes the “sleeve-like” bellows 300 with the fiber cords 332, etc. The air spring 500 may have the same or similar features and/or functions as the air spring 200. The air spring 500 includes different endcaps 510, 520 compared to the air spring 200. The endcap 510 includes a first mounting stud 512 and a second mounting stud 513. The second mounting stud 513 may be or include a pneumatic coupling. The pneumatic coupling of the mounting stud 513 may be the same or similar as the coupling 214 but located on the axial end of the upper endcap 510. The endcap 520 may be the same or similar as the endcap 220, but without the cavity 228.

FIG. 4B shows an embodiment of an air spring 501 that includes another embodiment of a bellows 600. The bellows 600 may have the same or similar features and/or functions as the bellows 300 except that it has a slightly rounded sidewall as shown. The bellows 600 may have the slightly rounded shape under zero pressure internally, under slight pressure internally, and/or under maximum internal pressure. Further, the bellows 600 has a first lobe 601 and a second lobe 602, which may be similar to the lobes described with respect to the air spring 200, except that the lobes 601, 602 extend radially beyond an outermost width or diameter of endcaps 530, 532. The endcap 530 includes a central attachment feature shown as a hole 531, which may be used for mounting the air spring to a structure. The endcap 532 includes another attachment feature which incorporates a coupling 533, such as a pneumatic coupling, which may be the same or similar as the coupling 214 but located on the axial end of the lower endcap 532.

FIG. 4C shows an embodiment of an air spring 502 that includes another embodiment of a bellows 700. The bellows 700 may have the same or similar features and/or functions as the bellows 300 with the cords 332 etc., except that the bellows 700 is a “bulge” style with a sidewall that bulges radially outward relative to the longitudinal axis. The cross-sectional shape of the bulge-style bellows 700, as taken in a plane perpendicular to the longitudinal axis defined by the bellows 700, may vary in width, e.g., diameter, along the axis. The bellows 700 may have the bulging shape under zero pressure internally, under slight pressure internally, and/or under maximum internal pressure. The air spring 502 includes an upper endcap 540 having openings 541, 542, 543, some of which may includes couplings, such as pneumatic couplings, similar to the coupling 214 but located on the axial end of the upper endcap 540.

FIGS. 4D and 4E show embodiments of air springs 503 and 504 respectively having a bellows 700 with multiple spherical bulges or bulging sections. The air spring 503 includes the bellows 700 with two bulging sections and the air spring 504 includes the bellows 700 with three bulging sections. Each of the bellows 700 may have the bulge shape as described herein. The bellows 700 is a continuous, monolithic piece of material with the bulging section separated from an adjacent bulging section by a fitting 555, such as a radial retaining ring, located between adjacent bulging sections. The plies of cords 332 may extend continuously along the axial length of the bulging sections, for example from the top of the uppermost bulging section to the bottom of the lowermost bulging section. The fitting 555 may extend annularly about an axial station located along the axial length of the bellows 700. The fitting or fittings 555 may be located such that the bulging sections have equal or approximately equal axial lengths. There may be a continuous internal air cavity between adjacent bulging sections of the bellows 700. There may be one or two of the fittings 555 as shown, or more for example in embodiments with four or more of the bulging sections. The air springs 503, 504 include the endcaps 540, 544. The internal air cavity may extend continuously from the upper endcap 540 to the lower endcap 544. In some embodiments, the bulging sections may be separate bellows attached together at the fitting(s) 555 and the respective endcaps 540, 544.

FIG. 4F shows an embodiment of an air spring 505 that includes another embodiment of a “sleeve-like” bellows 800 having a restraining cylinder 556. FIG. 4G is a partial cross-section view of the air spring 505 with the restraining cylinder 556 partially cross-sectioned along lines 4G-4G as shown in FIG. 4F. The air spring 505 may have the same or similar features and/or functions as the air spring 200, and vice versa, except as described herein.

The air spring 505 may include an upper endcap 550. The endcap 550 may include a coupling 552, such as a pneumatic coupling, which may be similar to the coupling 214. The endcap 550 may be sealingly attached to an upper end of the bellows 800. The air spring 505 may include a lower endcap 560 sealingly attached to a lower end of the bellows 800. The lower endcap 560 may connect to a radially inner side of the lower end of the bellows 800.

The air spring 505 may be integrated with a damper 557. The damper 557 includes a damper body 553 and a damper shaft 554. The damper body 553 may be sealingly attached to a lower endcap 560. The damper shaft 554 may be sealingly attached to an upper endcap 550. In some embodiments, the lower endcap 560 may be integral with the damper body 553. A mounting stud 559 may be located at a lower end of the lower body 553 and be configured to attach to a structure of the automobile or other apparatus.

The bellows 800 may only have a single ply of fiber cords 332. In some embodiments, there may be two or more plies of cords 332. The cords 332 may be placed vertically so that they are aligned axially with the longitudinal axis (shown in FIG. 4G). In some embodiments, some or all of the cords 332 may be angled with respect to the axis.

The air spring 505 includes a restraining cylinder 556, such as a radial restraining cylinder. The restraining cylinder 556 may be in contact or configured to be in contact with the radially outer surface or layer of the elastomer substrate of the bellows 800. The restraining cylinder 556 limits the inflated width, e.g. diameter, of the bellows 800. In other embodiments of the air springs described herein that may have the cords 332 arranged parallel to the axis, the restraining cylinder 556 or versions thereof may be included as well. Axially-aligned cords may provide little or no resistance to radially outward forces applied by internal air pressure from inflation of the bellows 800. The restraining cylinder 556 may bias the bellows 800 to form a cylinder upon inflation, and prevent the bellows 800 from forming a more spherical shape. The restraining cylinder 556 may be cylindrical as shown, or it may have other suitable shapes. As shown, the restraining cylinder 556 may include an outward bulge or ridge located along a length thereof, such as at an upper end of the restraining cylinder 556. The bellows 800 may axially retain the restraining cylinder 556 at this wider portion of the restraining cylinder.

The bellows 800 extends from an upper end 802 to a lower end 804. The upper end 802 may be attached to the upper endcap 550. The lower end 804 may be attached to the lower endcap 560. The bellows 800 may include an intermediate portion 806 located between the upper and lower ends 802, 804. The intermediate portion 806 may be a straight section prior to inflation. The intermediate portion 806 may be radially restrained by the restraining cylinder 556. A section of the bellows 800 may be radially unrestrained, such as a portion of the bellows 800 located at or near the upper end 802. The restraining cylinder 556 may not extend to the upper end of the bellows 800 when assembled. This section of the bellows 800 between the restraining cylinder 556 and the upper end cap 550 may be left radially unrestrained, thus creating a flexible joint which may allow the upper end cap 550 the flexibility to be non-parallel with the lower end cap 560. In some embodiments, the radially unrestrained section of the bellows may be in other locations along the length of the bellows. The unrestrained section may be a small portion of the axial length of the bellows 800, such as 5% or less, 10% or less, or 20% or less of the total axial length of the bellows 800.

These are just some other example embodiments of air springs that may incorporate the bellows development described herein. The air spring may include any variation of the variety of bellows, endcaps, fittings, etc. from the various embodiments as described herein, which may be used for automobile or other applications.

It will be appreciated by those skilled in the art that various modifications and changes may be made without departing from the scope of the described technology. Such modifications and changes are intended to fall within the scope of the embodiments. It will also be appreciated by those skilled in the art that parts included in one embodiment are interchangeable with other embodiments; one or more parts from a depicted embodiment may be included with other depicted embodiments in any combination. For example, any of the various components described herein and/or depicted in the figures may be combined, interchanged or excluded from other embodiments.

Various features from other disclosures may be incorporated into the various systems, devices and methods for the air spring described herein, and vice versa, such as features described, for example, in U. S. Pub. No. 2016/0153513, titled “Air spring bellows including renewable resources,” and published Jun. 2, 2016, in U.S. Pat. No. 6,145,894, titled “Push-pull connector and air spring-combination,” and issued Nov. 14, 2000, in U.S. Pat. No. 9,127,737, titled “Unreinforced elastomeric spring wall, gas spring and method,” and issued Sep. 8, 2015, in U.S. Pat. No. 9,163,689, titled “Elastomeric articles with improved properties,” and issued Oct. 20, 2015, in U.S. Pat. No. 9,914,821, titled “Air springs with improved high temperature performance,” and issued Mar. 13, 2018, in U.S. Pat. No. 3,980,606, titled “Polyurethane elastomers having prolonged flex life and tires made therefrom,” and issued Sep. 14, 1976, in U. S. Pub. No. 2019/0032703, titled “Ball Joint For A Vehicle, In Particular For An Off-Road Vehicle,” and published Jan. 31, 2019, in European Patent Publication No. 1843060, titled “Wear-resistant pneumatic springs,” and published Oct. 10, 2007, and in European Patent Publication No. 2039966, titled “Bellows Device,” and published Mar. 25, 2009, the entire disclosures of each of which is incorporated by reference herein.

Any processes or steps of any flow charts described and/or shown herein are illustrative only. A person of skill in the art will understand that the steps, decisions, and processes embodied in the flowcharts described herein may be performed in an order other than that described herein. Thus, the particular flowcharts and descriptions are not intended to limit the associated processes to being performed in the specific order described.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. An air spring for an automotive air suspension system, the air spring comprising:
a first end cap configured to attach to a first vehicle component;
a bellows having a rounded sidewall defining a longitudinal axis and extending from a first rounded opening to a second rounded opening opposite the first rounded opening to define an internal cavity, the first rounded opening sealingly attached to the first end cap, the internal cavity configured to receive pressurized air therein, and the bellows sidewall including:
a flexible elastomeric substrate that comprises polyurethane, the substrate comprising an inner layer, an outer layer located radially outward from the inner layer relative to the longitudinal axis, and a middle layer located in between the inner and outer layers,
a first ply comprising a first series of parallel fiber cords, the first ply located in between the inner and middle layers of the substrate such that the first series of parallel fiber cords extend at an angle with respect to the longitudinal axis, and
a second ply comprising a second series of parallel fiber cords, the second ply located in between the middle and outer layers of the substrate such that the second series of parallel fiber cords extend at an angle with respect to the longitudinal axis and with respect to the first series of parallel fiber cords, and such that the first and second series of parallel fiber cords define a series of equally-sized cells; and
a second end cap sealingly attached to the second rounded opening of the bellow, the second end cap configured to attach to a second vehicle component.

2. The air spring of claim 1, wherein the polyurethane is different from a thermoplastic polyurethane.

3. An air spring for an automotive air suspension system, the air spring comprising:
a bellows having a rounded sidewall defining an axis and extending from a first rounded opening to a second rounded opening and configured to receive pressurized air therein, the bellows including a flexible elastomeric substrate that comprises polyurethane.

4. The air spring of claim 3, further comprising:
a first end cap attached to the first rounded opening; and
a second end cap attached to the second rounded opening.

5. The air spring of claim 3, wherein the elastomeric substrate is translucent.

6. The air spring of claim 3, wherein the elastomeric substrate is transparent.

7. The air spring of claim 3, further comprising a plurality of fiber cords embedded within the elastomeric substrate.

8. The air spring of claim 7, wherein a first end of the fiber cords begins at the first rounded opening and a second end of the fiber cords ends at the second rounded opening.

9. The air spring of claim 7, wherein the fiber cords are equally spaced from one another.

10. The air spring of claim 7, wherein the fiber cords are oriented at an angle with respect to the axis.

11. The air spring of claim 7, wherein the fiber cords comprise a first plurality of fiber cords located on a first ply, the first ply being located on a first side of a layer of the substrate of the sidewall.

12. The air spring of claim 11, wherein the fiber cords further comprise a second plurality of fiber cords located on a second ply, the second ply being located on a second side of the layer of the substrate that is opposite from the first side.

13. The air spring of claim 12, wherein the first and second plies are oriented such that the first fiber cords are angled with respect to the second fiber cords.

14. The air spring of claim 7, wherein the fiber cords are angled with respect to each other so as to define a plurality of cells.

15. The air spring of claim 14, wherein the cells are sized according to an operating parameter of the air spring.

16. The air spring of claim 15, wherein the operating parameter comprises one or more of a load on the air spring, an operating temperature range of the air spring, and size of the air spring.

17. The air spring of any of claim 3, wherein the polyurethane is different from a thermoplastic polyurethane.

18. The air spring of claim 7, wherein the fiber cords extend parallel to the axis.

19. A bellows for an air spring, the bellows being formed of a material comprising an elastomer that comprises polyurethane.

20. The bellows of claim 19, wherein the elastomer comprises only polyurethane.

21. The bellows of claim 19, wherein the elastomer comprises more than 50% polyurethane by weight or volume of the elastomer.

22. The bellows of claim 19, wherein the polyurethane is different from a thermoplastic polyurethane.
